(19) United States
(12) Patent Application Publication
(10) Pub. No.: US 2024/0193634 A1
(43) Pub. Date: Jun. 13, 2024

(54) METHOD AND SYSTEM FOR PROVIDING A POINT-BASED SUBSCRIPTION PLAN TO A USER

(71) Applicant: Yahoo Ad Tech LLC, Dulles, VA (US)

(72) Inventor: Gnanavel SHANMUGAM, San Jose, CA (US)

(21) Appl. No.: 18/063,259

(22) Filed: Dec. 8, 2022

(51) Int. Cl. G06Q 30/0226; H04L 67/306

(52) U.S. Cl. CPC G06Q 30/0226; H04L 67/306

(57) ABSTRACT

A computer-implemented method provides features of a point based subscription plan to a user of a product. The method comprises providing actions to a user device of the user, each action having an associated point value, receiving an indication that the user has completed at least one action, determining a number of earned points by the user based on the at least one completed action and the corresponding associated point value, storing the number of earned points by the user in a user profile, determining whether a total number of earned points is equal to or greater than a threshold number of points, and providing the features of the point-based subscription plan to the user, upon determining that the total number of earned points is equal to or greater than the threshold number of points.

### DETAILED DESCRIPTION

### Technical Field

The present disclosure relates to techniques for providing point-based actions to a user of a product and, based on completion of the point-based actions, providing one or more features of the product to the user.

### Background

Providers of products, such as e-mail providers, offer various features of those products to users. Features may be provided for free to users along with advertisements, or features, referred to as premium features, may be provided behind a paywall. Users of the products can access premium features when buying a subscription plan for the products. However, users have limited control over which features, of the premium features, are included in the subscription plan.

Providers typically bundle some or all premium features together as a means of adding value for a subscription plan. Pricing of individual premium features is not an easy way to scale premium business. Due to the lack of options for choosing individual premium features, very few users opt to buy subscription plans. That is, because of the relatively high cost for the subscription plans, and because users do not necessarily need or want some of the premium features included in a bundle of a given subscription plan, users do not opt to buy subscription plans that include premium features.

The following disclosure provides a solution to the aforementioned technological voids.

### SUMMARY OF THE DISCLOSURE

Embodiments of the present disclosure include systems and methods for providing one or more features of a point based subscription plan to a user of a product.

In one aspect, a computer-implemented method provides one or more features of a point based subscription plan to a user of a product. The method comprises providing, using at least one processor of a server, one or more actions to a user device of the user, each action of the one or more actions having an associated point value, receiving, using the at least one processor, from the user device, an indication that the user has completed at least one of the one or more actions, determining, using the at least one processor, a number of earned points by the user based on the at least one completed action and the corresponding associated point value of the at least one completed action, storing, using the at least one processor, the number of earned points by the user in a user profile for the user, determining, using the at least one processor, whether a total number of earned points by the user is equal to or greater than a threshold number of points, and providing, using the at least one processor, to the user device, the one or more features of the point-based subscription plan to the user, upon determining that the total number of earned points is equal to or greater than the threshold number of points.

In another aspect, a system provides one or more features of a point based subscription plan to a user of a product. The system comprises at least one server, a storage device that stores instructions, and at least one processor that executes instructions the instructions to perform a method comprising providing, using at least one processor of a server, one or more actions to a user device of the user, each action of the one or more actions having an associated point value, receiving, using the at least one processor, from the user device, an indication that the user has completed at least one of the one or more actions, determining, using the at least one processor, a number of earned points by the user based on the at least one completed action and the corresponding associated point value of the at least one completed action, storing, using the at least one processor, the number of earned points by the user in a user profile for the user, determining, using the at least one processor, whether a total number of earned points by the user is equal to or greater than a threshold number of points, and providing, using the at least one processor, to the user device, the one or more features of the point-based subscription plan to the user, upon determining that the total number of earned points is equal to or greater than the threshold number of points.

In still another aspect, a non-transitory computer readable medium stores instructions for providing one or more features of a point based subscription plan to a user of a product. The instructions are configured to cause at least one processor to perform a method comprising providing, using at least one processor of a server, one or more actions to a user device of the user, each action of the one or more actions having an associated point value, receiving, using the at least one processor, from the user device, an indication that the user has completed at least one of the one or more actions, determining, using the at least one processor, a number of earned points by the user based on the at least one completed action and the corresponding associated point value of the at least one completed action, storing, using the at least one processor, the number of earned points by the user in a user profile for the user, determining, using the at least one processor, whether a total number of earned points by the user is equal to or greater than a threshold number of points, and providing, using the at least one processor, to the user device, the one or more features of the point-based subscription plan to the user, upon determining that the total earned number of points is equal to or greater than the threshold number of points.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a schematic diagram illustrating an example of a network within which the systems and methods disclosed herein could be implemented, according to embodiments of the present disclosure.

FIG. 2 is a schematic diagram illustrating an example of a system within which the methods disclosed herein could be implemented according to embodiments of the present disclosure.

FIG. 3 depicts a flowchart for a method for providing one or more features of a point based subscription plan to a user of a product, according to embodiments of the present disclosure.

FIG. 4 depicts additional steps of the method shown in FIG. 3.

FIGS. 5 to 7 depict additional steps of the method shown in FIG. 3.

FIG. 8 depicts a graphical representation of a user interface in which one or more actions are provided, according to embodiments of the present disclosure.

FIG. 9 depicts another graphical representation of a user interface in which one or more features are provided, according to embodiments of the present disclosure.

### DETAILED DESCRIPTION OF EMBODIMENTS

As described herein, embodiments of the present invention are directed to a method for providing one or more features of a point based subscription plan to a user of a product, as well as a related system and non-transitory computer-readable storage medium. The method may include at least the steps of providing, using at least one processor of a server, one or more actions to a user device of the user, each action of the one or more actions having an associated point value, and receiving, using the at least one processor, from the user device, an indication that the user has completed at least one of the one or more actions. The method may also include the steps of determining, using the at least one processor, an earned number of points by the user based on the at least one completed action and the corresponding associated point value of the at least one completed action, and storing, using the at least one processor, the earned number of points by the user in a user profile for the user. Further, the method may include the steps of determining, using the at least one processor, whether a total earned number of points by the user is equal to or greater than a threshold number of points, and providing, using the at least one processor, to the user device, the one or more features of the point-based subscription plan to the user, upon determining that the total earned number of points is equal to or greater than the threshold number of points. These as well as other aspects of the present invention are described in more detail below.

While principles of the present disclosure are described herein with reference to illustrative embodiments for particular applications, it should be understood that the disclosure is not limited thereto. Those having ordinary skill in the art and access to the teachings provided herein, will recognize that the features illustrated or described with respect to one embodiment, may be combined with the features of another embodiment. Therefore, additional modifications, applications, embodiments, and substitution of equivalents, all fall within the scope of the embodiments described herein. Accordingly, the invention is not to be considered as limited by the foregoing description. Various non-limiting embodiments of the present disclosure will now be described to provide an overall understanding of the principles of the structure, function, and use of systems and methods for recommending where to conduct a transaction.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer readable medium (or computer-readable storage medium/media) stores computer data, which data can include computer program code (or computer-executable instructions) that is executable by a computer, in machine-readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, cloud storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure, the term “server” should be understood to refer to a service point that provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software, for example virtual servers, and one or more database systems and application software that support the services provided by the server. Cloud servers are examples.

For the purposes of this disclosure, a “network” should be understood to refer to a network that may couple devices so that communications may be exchanged, such as between a server and a personal computing device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof Likewise, sub-networks, which may employ differing architectures or may be compliant or compatible with differing protocols, may intemperate within a larger network.

For purposes of this disclosure, a “wireless network” should be understood to couple personal computing devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router (WR) mesh, or 2nd, 3rd, 4th or 5th generation (2G, 3G, 4G or 5G) cellular technology, Bluetooth, 802.llb/g/n, or the like. Network access technologies may enable wide area coverage for devices, such as personal computing devices with varying degrees of mobility, for example.

In short, a wireless network may include virtually any type of wireless communication mechanism by which signals may be communicated between devices, such as a personal computing device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a personal computing device may include a computing device capable of sending or receiving signals, such as via a wired or a wireless network. A personal computing device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A personal computing device may vary in terms of capabilities or features. Claimed subject matter is intended to cover a wide range of potential variations, such as a web-enabled personal computing device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display and components for displaying augmented reality objects, for example.

A personal computing device may include or may execute a variety of possible applications, such as a client software application enabling communication with other devices. A personal computing device may also include or execute an application to communicate content, such as, for example, textual content, multimedia content, or the like. A personal computing device may also include or execute an application to perform a variety of possible tasks, such as: browsing, searching, connecting to a network (e.g. the internet), receiving communications (e.g. phone call, emails, text messages, social media communications), streaming or displaying various forms of content, including locally stored or uploaded images and/or video, or games (such as live video calls).

As discussed herein, a user is an individual who uses a system in accordance with the embodiments described here. However, the concept of a user is meant to be exemplary, as there may be one or more users, a user group, or a combination thereof, that access the system.

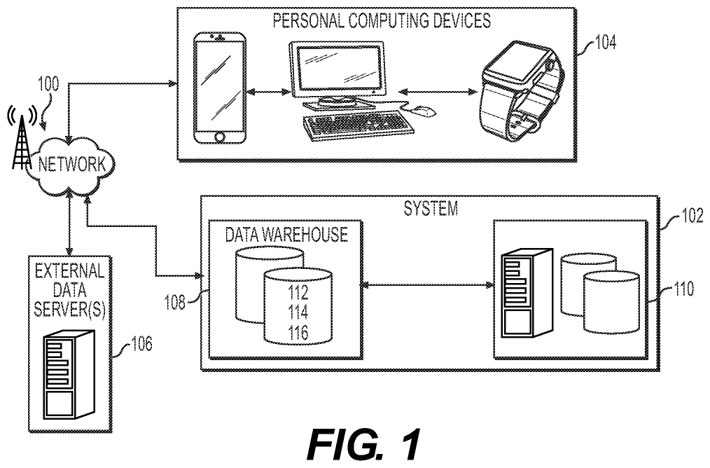

FIG. 1 depicts an example of a network 100 within which a system 102, as disclosed herein, could be implemented. Through the network 100, the system 102 is connected to one or more user devices 104 belonging to one or more users. As an example, a user device 104 may be a smartphone, although other devices may be used, such as a personal computer, a laptop, a tablet, a smartwatch, or other devices.

The system 102 is also connected to one or more external data servers 106, which store data received from the one or more user devices 104 and from the system 102. The external data server(s) 106 may include one or more of personal computers desktop computers, multiprocessor systems, microprocessor-based or programmable consumer electronics, database(s), network PCs, server(s), and the like, maintained by third parties storing business-to-business or business-to-consumer data (e.g. Verizon®, Apple®, Google®, Netflix®, Nordstrom®, Amazon®, a government entity, or the like). The system 102 may receive data stored on the external data server(s) 106 on one or more of its computing devices. The data stored at the external data server(s) 106 may include, without limitation, information related to: brand(s), brand product(s), brand service(s), product cost, service cost, subscription plan(s), including premium features, rewards, and/or points information, mobile devices (e.g. iPhone®), smart accessories (e.g. Apple Watch®), artificial intelligence enabled devices (e.g. Alexa®, Google Home®, Facebook Portal®, and the like), and GPS data corresponding to a user device 104. Data relating to subscription plan(s) may include actions 114 and features 116 thereof. The data may also include data specific to a user, obtained via connection to a user device 104, including, for example, user profile(s) 112, contents of an e-mail inbox of a user, and a user web browser history within the network. The system 102 may receive or may be able to parse data from the external data server(s) 106 pertaining to specific user(s) whose user devices 104 are connected within the network 100. The system 102 may include a data warehouse 108 and an internal server 110, which may include additional data storage and one or more processors.

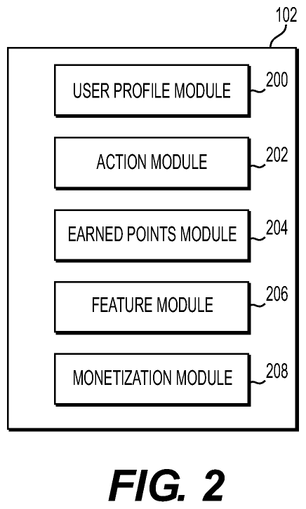

FIG. 2 is a schematic diagram illustrating an example of the system 102 within which the methods disclosed herein may be implemented. The system 102 may include modules programmed to perform certain steps of the methods disclosed herein. The modules may include, without limitation, a user profile module 200, an action module 202, an earned points module 204, a feature module 206, and a monetization module 208. While examples of functionalities of modules 200, 202, 204, 206, and 208 will now be described, it should be appreciated that in some cases, the functionalities of these modules may be combined into one or more modules, or a functionality attributed to one module may be split across one or more other modules.

In one embodiment, the user profile module 200 is a component of the system 102 that may be responsible for generating, maintaining, and updating a user profile 112 (FIG. 1) for a user. Generating, maintaining, and updating the user profile 112 may be based on one or more product or service subscriptions of the user, and the content of the product subscription. For example, a user may be subscribed to an e-mail service, and the content of the user's subscription may be data relating to the electronic mailbox, such as the electronic mailbox depicted in FIGS. 6 and 7. The user profile 112 may be generated, maintained, and updated based on a user's actions within the product or service, such as a user completing one or more actions 114, as described in more detail below. Upon completion of one or more actions 114, the user profile module 200 may generate and/or update an earned point value of the user based on information received from the earned points module 204. That is, the user profile module 200 may be responsible for storing the earned number of points by the user in the user profile 112. The user profile 112 may also be generated, maintained, and updated based on the user's navigation history across the network 100.

The action module 202 is a component of the system 102 that may be responsible for generating and providing, or outputting, to a user device, one or more actions 114 for a user to complete. The actions 114 may include, without limitation, selecting an advertisement (“click deals”), purchasing a subscription product, signing up to receive messages from one or more entities, or opening messages from one or more entities. Each action 114 has an associated point value, that is, a number of points, by which, by completing a given action 114, a user can earn the number of points associated with that action 114. The associated point value for a given action 114 may be based on a monetization value of the action 114, and vice versa. The user can perform any of the available actions 114 to accrue points and, for example, to work towards a goal, which may be, for example, to reach a certain threshold number of points in order to access and use a feature 116. The actions 114 may include at least one high value action and at least one non-high value action, with a high value action having an associated point value that is greater than that of a non-high value action. A high value action may be, for example, linking a user's e-mail account to another service such that, once the e-mail account is linked, the user receives e-mails related to that service or related to other products. Other examples of high value actions include, without limitation, driving click through rates, a total number of a views (such as views of an advertisement), time spent watching or consuming content, and/or completion of a transaction. High value actions may also be determined based on a time of day. Rules for engaging with high value actions may be different for each action 114, and points may be provided to the user only if the user completes the action 114 in compliance with those rules. In some embodiments, the actions 114 may be provided to the user device 104 for a predetermined amount of time (that is, for a limited amount of time). In some embodiments, the actions 114 may be provided to the user device 104 for a predetermined number of instances. In addition, in some embodiments, an associated point value for an action 114 may be changed or updated by, for example, the action module 202, based on a level of user engagement with actions 114. For example, if a user 114 completes a certain number of actions 114, within a certain period of time, associated point values for actions 114 to be completed by the user may be increased, in order to incentivize the user to continue completing actions 114.

By limiting the time and the number of instances for which the user can complete the actions 114 via the user device 104, it is possible to limit the number of points that the user may earn or accumulate, particularly with in a short amount of time. In addition, limiting the time and number of instances for which the user can complete the actions 114 provides an incentive to the user to complete actions 114 when presented with same, rather than delaying completion and/or ignoring a notification that an action 114 is available.

The action module 202 may also be responsible for receiving, from a user device 104, an indication that the user has completed one or more actions 114. The action module 202 may then send an indication to one or more of the earned points module 204, the feature module 206, and the monetization module 208, that the user has completed one or more actions 114.

The earned points module 204 is a component of the system 102 that may be responsible for determining an earned number of points by the user based on the completed actions 114, and storing the earned number of points in the user profile 112. That is, for each action 114 that the user completes, the earned points module 204 may retrieve an associated point value for the completed action 114, and may send the retrieved associated point value to the user profile module 200 for updating and storing an earned point value for the user in the user profile 112. Alternatively, the storing of the earned number of points in the user profile 112 may be performed by the user profile module 200, as noted above.

The earned points module 204 may also be responsible for determining whether a total number of earned points by the user is equal to or greater than a threshold number of points. That is, the earned points module 204 may retrieve a total number of earned points by the user from the user profile module 200, and compare the total number of earned points by the user to a threshold number of points. The earned points module 204 may then send a result of the comparison to the feature module 206.

The feature module 206 is a component of the system 102 that may be responsible for receiving the result of the comparison of the total number of earned points by the user to the threshold number of points, and providing one or more features 116 of a point-based subscription plan to a user based on the comparison. The features 116 may include, without limitation, message-to-message navigation within a message inbox, display of a compose message in a separate window from a message inbox window containing the message inbox, the separate window being smaller than the message inbox window and in front of the message inbox window, domain blocking, providing reminders to send a reply to a message in the message inbox, or providing the product without advertisements. In particular, if a result of the comparison performed by the earned points module 204 includes a determination that the total number of earned points by the user is equal to or greater than the threshold number of points, the feature module 206 may provide one or more features of the point-based subscription plan to the user, by transmitting instructions for a notification to be displayed to the user via the user device 104. In addition, if a result of the comparison includes a determination that the total number of earned points by the user is not equal to or greater than the threshold number of points, the feature module 206 may not send one or more features to the user.

The feature module 206 may provide features 116 to the user device 104 upon receiving a selection by a user to access or unlock a feature 116, and upon determining that the total number of earned points is equal to or greater than the threshold number of points for that feature 116. In addition, the feature module 206 may provide a plurality of features 116, based on selection of those features 116 by the user and based on determining that the user has earned the threshold number of points for each feature 116. That is, if a user selects two features 116, each having a threshold number of points and, collectively, requiring a combined threshold number of points for access to the features 116, the feature module 206 determines whether the total number of earned points by the user is equal to or greater than the combined threshold number of points, so that the user may access both of the features 116 selected. In addition, the feature module 206 may periodically (that is, at predetermined time intervals) determine whether the user has continued to earn a sufficient number of points to continue accessing and using the features 116. For example, once each month, the feature module 206 may retrieve the total number of earned points since the user last redeemed points, and determine whether that total number of earned points exceeds a threshold number of points to continue using the feature 116.

Although a single threshold number of points is discussed with respect to the functionalities of the earned points module 204 and the feature module 206, multiple thresholds of numbers of points may be used, and, accordingly, multiple comparisons of the total number of earned points may be made. For example, if the point-based subscription plan includes two or more features 116, each of the two or more features 116 may be associated with a threshold number of points, such that a first feature 116 has an associated first threshold number of points, a second feature 116 has an associated second threshold number of points, and so on. And, in a case in which the point-based subscription plan includes premium feature(s) as well as non-premium, or regular, features, the premium feature(s) may have a relatively higher associated threshold number of points, comparted to that of the non-premium features. In this manner, the total number of earned points may be compared to the multiple thresholds to determine whether the user has earned enough points for access to the non-premium and/or the premium features.

The feature module 206 may also send an indication to the earned points module 204 indicating that the user has redeemed points, of the total number of earned points, in exchange for access to, or unlocking of, a feature 116. The earned points module 204 may then update the total number of earned points, such as reducing the total number of earned points by the amount of points associated with the feature 116, which the user has now redeemed. In this way, the user trades earned points for features 116 of the point-based subscription service.

The monetization module 208 is another component of the system 102 that may be responsible for determining a total monetization value of completed actions 114, and sending a request to a system of a third party for payment based on the determined total monetization value of the completed actions 114. That is, each action 114 may have an associated or corresponding monetization value. The monetization module 208 may receive an indication from the action module 202 that the user has completed an action 114, and may retrieve the corresponding monetization value for the completed action 114. This process may be performed for each completed action 114, and the monetization module 208 may determine a total monetization value for the completed actions 114. The monetization module 208 may then send a request to a system of a third party for payment based on the determined total monetization value for the completed actions 114.

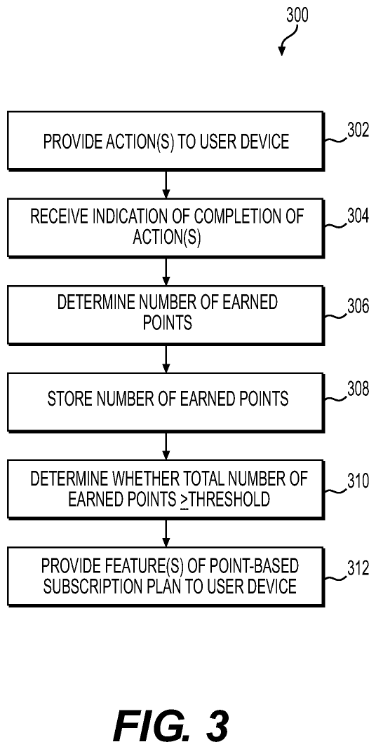

FIG. 3 depicts a flowchart for a method for providing one or more features of a point based subscription plan from a system, such as the system 102 described herein, to a user of a product, according to embodiments of the present disclosure. In particular, FIG. 3 depicts the steps of a method 300, including a step 302 of providing one or more actions 114 to a user device 104. As noted above, each of the actions 114 has an associated point value. In step 304, the system 102 receives, from the user device 104, an indication that the user has completed at least one action 114. In step 306, the system 102 determines an earned number of points by the user based on the completed action 114 and the corresponding associated point value of the completed action. This step may be performed for each completed action 114 by the user.

The method 300 may also include a step 308 of storing the earned number of points by the user in a user profile 112. In step 310, the system 102 determines whether a total number of earned points by the user is equal to or greater than a threshold number of points. Step 310 may be performed upon receiving a selection by a user to access or unlock a feature. In addition, step 310 may be performed for a plurality of threshold numbers of points, as discussed above, and in response to a user selecting a plurality of features the user wishes to access or unlock. In some embodiments, step 310 may be performed at predetermined time intervals, such as once each month, to determine whether the user has continued to earn points to continue having access to one or more features 116 of the point-based subscription plan. Then, in step 312, the system 102 provides one or more features of the point-based subscription plan to the user device 104. Step 312 is performed upon determining, in step 310, that the total number of earned points is equal to or greater than the threshold number of points. And, in a case in which it is determined that the total earned number of points is equal to or greater than two or more threshold numbers of points, step 312 may be performed for each feature associated with the two or more threshold number of points.

Although the method 300 is described as included steps 302 to 312, the method 300 is not limited to these steps, and may include additional or alternative steps. In addition, although steps 302 to 312 of the method 300 are described in a particular order, it is within the scope of the invention to modify the order in which the steps are performed, as appropriate.

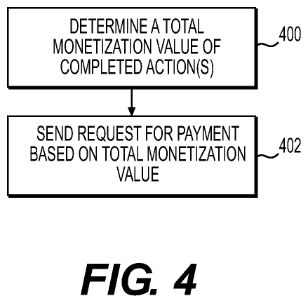

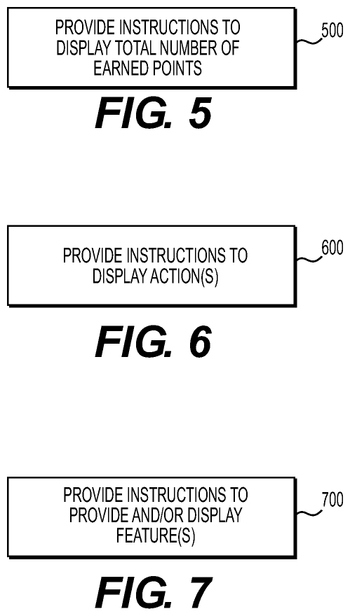

FIG. 4 depicts additional steps of the method 300 shown in FIG. 3. In particular, FIG. 4 depicts a step 400 of determining, based on the completed at least one action and a corresponding associated monetization value, a total monetization value of the completed at least one action 114, and a step 402 of sending a request to a system of a third party for payment based on the total monetization value of the completed at least one action 114. FIGS. 5 to 7 depict additional steps of the method 300 shown in FIG. 3. In particular, FIG. 5 depicts a step 500 of providing instructions to the user device 104 to display a total number of earned points. In other words, a user's progress in earning points may be displayed, such that the user knows an amount of points they have earned. This step 500 may also include displaying a number of points that the user needs to earn, in addition to the total number of points already earned, in order to access, or unlock, a feature 116. FIG. 6 depicts a step 600 of providing instructions to the user device 104 to display actions 114 to be completed by the user. Step 600 may include displaying a duration or a period of time in which the user may complete the action 114. FIG. 7 depicts a step 700 of providing instructions to the user device 104 to provide and/or display features 116 for which the user has redeemed points.

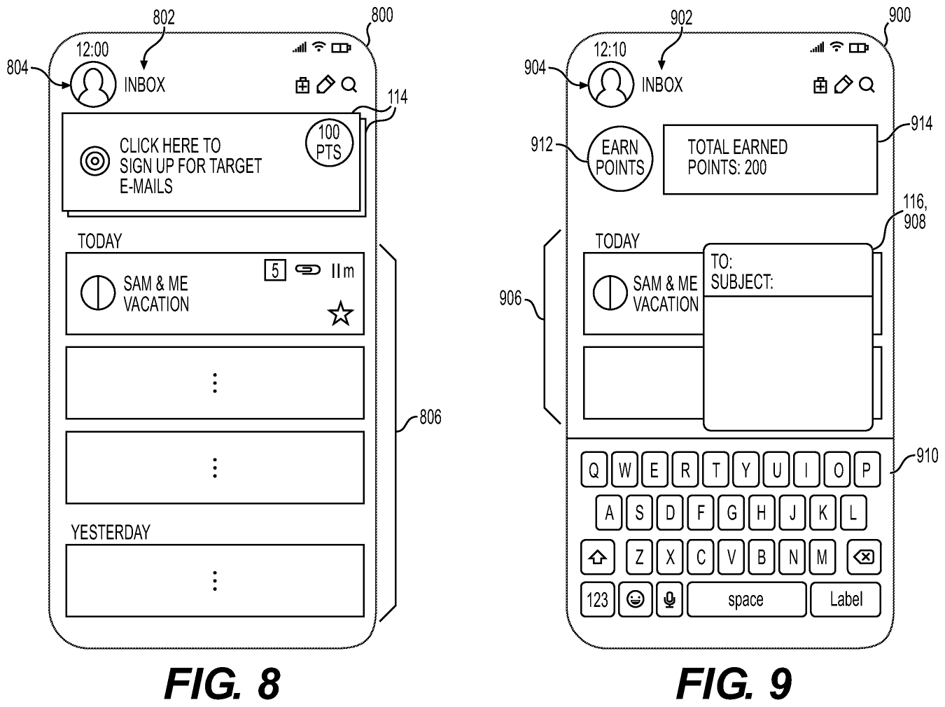

FIG. 8 depicts a graphical representation of a user interface 800 of the user device 104, in which one or more actions 114 are provided in an inbox 802 of a user, according to embodiments of the present disclosure. In the example shown in FIG. 8, a user profile icon 804 may be shown for the user profile 112, and may include a thumbnail image of the user. One or more actions 114 are shown at a top of the inbox 802, and one or more messages 806 are shown below the one or more actions 114. In this example, the actions 114 include an action prompting the user to “CLICK HERE TO SIGN UP FOR TARGET E-MAILS” with a note indicating the action 114 will earn the user 100 points. Of course, as noted above, the actions 114 may include others types of actions having various associated point values. In the example interface 800 of FIG. 8, the actions 114 are depicted in an overlapping manner, but the actions 114 may be shown in a non-overlapping manner, such that the user can view all available actions 114.

FIG. 9 depicts another graphical representation of a user interface 900 of the user device 104, in which one or more features 116 are provided to the user, according to embodiments of the present disclosure. In the example shown in FIG. 9, an inbox 902 is shown, including a user profile icon 904 may be shown for the user profile 112, and may include a thumbnail image of the user. As with the interface 800 shown in FIG. 8, messages 906 may be shown. In addition, as a feature 116 provided to the user as a result of redeeming earned points, a compose message window 908, as a separate window from the inbox 902 containing the messages 906, is shown. The compose message window 908 is relatively smaller than the inbox 902, and is shown in front of the inbox 902. The compose message window 908 may also include or be shown adjacent to a keyboard 910, such as a QWERTY keyboard, as shown in FIG. 9. In addition, in the example interface 900, an earn points icon 912 is shown, which allows a user to view available actions 114 the user may complete to earn points. Also, a total earned points icon 914 is shown, which displays the total number of earned points by the user.

In the examples shown in FIGS. 8 and 9, and described above, the actions 114 and features 116 correspond to the particular user profile 112. The actions 114 and features 112 may be updated based on more recent and/or additional data received from a user device 104, and based on completion of actions 114 by the user and/or preferences of the user.

By virtue of the system and method described herein, it is possible to provide features to a user, while allowing users control the particular features of the point-based subscription services they wish to use. That is, a user may decide which features of the point-based subscription service they wish to use and allows the user to earn and redeem points to ultimately user those features. The user is therefore not required to purchase a relatively expensive subscription plan, including features that the user may not wish to use. By providing a point-based subscription plan and allowing users to earn points based on their usage of a service or a product, the system and method of the present disclosure provide users with the ability to trade, or redeem, points to access and use the features they want to use, at no added cost. And, by allowing a user to choose the particular actions the user completes, the user's engagement with a product or service, including advertisements provided through that product or service, may increase. Increasing engagement with advertisements may result in increased advertisement revenue for the product or service provider. Also, by limiting the time and the number of instances for which the user can complete actions via the user device, the system and methods of the present disclosure make it possible to limit the number of points that the user may earn or accumulate, particularly with in a short amount of time, which provides an incentive to the user to complete actions when presented with same, rather than delaying completion and/or ignoring a notification that an action is available. And, by virtue of the monetization module tracking completing actions, determining the total monetization value, and sending the request for payment, the system and method of the present disclosure allow for monetization of the point-based subscription services, while maintaining the ability of users to control the particular features of the point-based subscription services they wish to use.

One having ordinary skill in the art will recognize that the aforementioned examples and embodiments are not meant to be limiting and can be implemented in combination with any disclosed features or other examples and embodiments.

1. A computer-implemented method for providing one or more features of a point based subscription plan to a user of a product, the method comprising:
providing, using at least one processor of a server, one or more actions to a user device of the user, each action of the one or more actions having an associated point value;
receiving, using the at least one processor, from an external data server, web browser history corresponding to the user device;
parsing, by the at least one processor, the web browser history to determine an indication that the user has completed at least one of the one or more actions;
determining, using the at least one processor, a number of earned points by the user based on the at least one completed action and the corresponding associated point value of the at least one completed action;
storing, using the at least one processor, the number of earned points by the user in a user profile for the user;
determining, at a predetermined time interval, using the at least one processor, whether a total number of earned points by the user is equal to or greater than a threshold number of points; and
providing, using the at least one processor, to a graphical user interface of the user device, the one or more features of the point-based subscription plan to the user, upon determining that the total number of earned points is equal to or greater than the threshold number of points.

2. The method of claim 1, wherein the one or more actions include two or more actions, including at least one high value action and at least one non-high value action.

3. The method of claim 2, wherein an associated point value of the at least one high value action is greater than an associated point value of the at least one non-high value action.

4. The method of claim 1, wherein the one or more actions are provided to the user device for a predetermined amount of time.

5. The method of claim 1, wherein the one or more actions are provided to the user device a predetermined number of instances.

6. The method of claim 1, wherein the one or more actions comprise at least one of selecting an advertisement, purchasing a subscription product, signing up to receive messages from one or more entities, or opening messages from one or more entities.

7. The method of claim 1, wherein the one or more features of the point-based subscription plan comprise at least one of message-to-message navigation within a message inbox, display of a compose message in a separate window from a message inbox window containing the message inbox, the separate window being smaller than the message inbox window and in front of the message inbox window, domain blocking, providing reminders to send a reply to a message in the message inbox, or providing the product without advertisements.

8. The method of claim 1, wherein each action, of the one or more actions, has an associated monetization value, and wherein the method further comprises:
determining, using the at least one processor, based on the completed at least one action and the corresponding associated monetization value, a total monetization value of the completed one or more actions; and
sending, using the at least one processor, a request to a system of a third party for payment based on the total monetization value of the completed at least one action.

9. A system for providing one or more features of a point based subscription plan to a user of a product, the system comprising:
at least one server;
a storage device that stores instructions; and
at least one processor that executes instructions the instructions to perform a method comprising:
providing, using at least one processor of a server, one or more actions to a user device of the user, each action of the one or more actions having an associated point value;
receiving, using the at least one processor, from an external data server, web browser history corresponding to the user device;
parsing, by the at least one processor, the web browser history to determine an indication that the user has completed at least one of the one or more actions;
determining, at a predetermined time interval, using the at least one processor, a number of earned points by the user based on the at least one completed action and the corresponding associated point value of the at least one completed action;
storing, using the at least one processor, the number of earned points by the user in a user profile for the user;
determining, using the at least one processor, whether a total number of earned points by the user is equal to or greater than a threshold number of points; and
providing, using the at least one processor, to a graphical user interface of the user device, the one or more features of the point-based subscription plan to the user, upon determining that the total number of earned points is equal to or greater than the threshold number of points.

10. The system of claim 9, wherein the one or more actions include two or more actions, including at least one high value action and at least one non-high value action.

11. The system of claim 10, wherein an associated point value of the at least one high value action is greater than an associated point value of the at least one non-high value action.

12. The system of claim 9, wherein the one or more actions are provided to the user device for a predetermined amount of time.

13. The system of claim 9, wherein the one or more actions are provided to the user device a predetermined number of instances.

14. The system of claim 9, wherein the one or more actions comprise at least one of selecting an advertisement, purchasing a subscription product, signing up to receive messages from one or more entities, or opening messages from one or more entities.

15. The system of claim 9, wherein the one or more features of the point-based subscription plan comprise at least one of message-to-message navigation within a message inbox, display of a compose message in a separate window from a message inbox window containing the message inbox, the separate window being smaller than the message inbox window and in front of the message inbox window, domain blocking, providing reminders to send a reply to a message in the message inbox, or providing the product without advertisements.

16. The system of claim 9, wherein each action, of the one or more actions, has an associated monetization value, and wherein the method further comprises:
determining, using the at least one processor, based on the completed at least one action and the corresponding associated monetization value, a total monetization value of the completed one or more actions; and
sending, using the at least one processor, a request to a system of a third party for payment based on the total monetization value of the completed at least one action.

17. A non-transitory computer-readable medium storing instructions for providing one or more features of a point based subscription plan to a user of a product, the instructions configured to cause at least one processor to perform a method comprising:
providing, using at least one processor of a server, one or more actions to a user device of the user, each action of the one or more actions having an associated point value;
receiving, using the at least one processor, from an external data server, web browser history corresponding to the user device;
parsing, by the at least one processor, the web browser history to determine an indication that the user has completed at least one of the one or more actions;
determining, using the at least one processor, a number of earned points by the user based on the at least one completed action and the corresponding associated point value of the at least one completed action;
storing, using the at least one processor, the number of earned points by the user in a user profile for the user;
determining, at a predetermined time interval, using the at least one processor, whether a total number of earned points by the user is equal to or greater than a threshold number of points; and
providing, using the at least one processor, to a graphical user interface of the user device, the one or more features of the point-based subscription plan to the user, upon determining that the total earned number of points is equal to or greater than the threshold number of points.

18. The non-transitory computer-readable medium of claim 17, wherein the one or more actions include two or more actions, including at least one high value action and at least one non-high value action.

19. The non-transitory computer-readable medium of claim 18, wherein an associated point value of the at least one high value action is greater than an associated point value of the at least one non-high value action.

20. The non-transitory computer-readable medium of claim 17, wherein the one or more actions are provided to the user device for a predetermined amount of time, and are provided to the user device a predetermined number of instances.
